(19) United States
(12) Patent Application Publication
(10) Pub. No.: US 2011/0170133 A1
(43) Pub. Date: Jul. 14, 2011

(54) IMAGE FORMING APPARATUS, METHOD OF FORMING IMAGE AND METHOD OF AUTHENTICATING DOCUMENT

(75) Inventors: Ilya V. Kurilin, Moscow (RU); Ilia V. SAFONOV, Moscow (RU)

(73) Assignee: Samsung Electronics Co,. Ltd., Suwon-si (KR)

(21) Appl. No.: 12/942,080

(22) Filed: Nov. 9, 2010

(30) Foreign Application Priority Data
Jan. 12, 2010 (RU) RU2010100795
Apr. 20, 2010 (KR) 2010-0036471

(51) Int. Cl. G06F 3/12; G06F 21/00

(52) U.S. Cl. 358/1.15; 726/26

(57) ABSTRACT

An image forming apparatus includes a communication interface unit to receive print data, a detection unit to detect a plurality of areas having a predetermined size from among print areas of the input print data, a controlling unit to generate a predetermined message as a plurality of image patterns, an embedding unit to embed the generated plurality of image patterns in the plurality of detected areas, and a printing unit to print the print data in which a plurality of image patterns are embedded.

### CROSS-REFERENCE TO RELATED APPLICATIONS

This application claims the benefit under 35 U.S.C. §119 of Korean Patent Application No. 2010-0036471, filed in the Korean Intellectual Property Office on Apr. 20, 2010, and Russian Patent Application No. 2010100795, filed in the Russian Intellectual Property Office on Jan. 12, 2010, the contents of which are incorporated herein by reference in its entirety.

### BACKGROUND

1. Field of the Invention

The present general inventive concept relates to an image forming apparatus, a method of forming an image, and a method of authenticating a document, and more particularly, to an image forming apparatus which is capable of embedding digital information in a document by embedding a small white speckle in the text area of the document, a method of forming an image including the embedded information, and a method of authenticating a document having the digital information embedded therein.

2. Description of the Related Art

In today's digital world, securing different forms of content is very important in terms of protecting copyright and verifying authenticity. One widespread example is watermarking of digital audio and images. However, marking scheme analogous to digital watermarking but for printed documents is also very important to prevent forgery or alteration of documents used for purposes of identity, security, or recording transactions.

There currently exist techniques to secure documents such as bank notes using paper watermarks, security fibers, holograms, or special inks. The problem is that the use of these security techniques can be costly. Most of these techniques either require special equipment to embed the security features or are simply too expensive for an average consumer.

Additionally, there are a number of applications in which it is desirable to be able to identify the technology, manufacturer, model, or even specific unit that was used to print a given document. Labeling of printed documents by embedding a unique message that is unnoticeable to the naked eye may provide a useful and inexpensive technique for document authentication.

A number of conventional techniques have been developed for document copyright protection, copy controlling, document annotation, and authentication via embedding some kind of protection information in a document. However, most of the methods developed today oriented on embedding information in multimedia documents or digital images cannot be directly applied to printed document due to a need for complicated printing, half-toning, etc.

An example of a related method of including information in a document is U.S. Patent Application 2009/0021795, which is directed to embedding an identifying pattern of visible speckles into the digitized image of a document in pseudo-random places. A speckle is a cluster of black or white pixels. Speckles are printed as black speckles on the white paper, or conversely, as areas of missing black removed from the black text characters, called white speckles.

The collective pattern of all embedded black and white speckles on a single document page is called a specklemark. Such specklemark may be removed by contrast manipulations on photocopiers and binary rasterization performed by fax scanning prior to data transmission.

Another related method, U.S. Pat. No. 6,983,056, is directed to a method for embedding watermarking information into a printed document. Firstly, an area of text lines is detected, then a subject image area (text lines) is split into sub-blocks and the sub-blocks are divided into groups. The sub-blocks belonging to one group are modified to increase the features and the sub-blocks belonging to the other group are modified to decrease the features. Features may include a thickness or height of symbols, for example. When the watermark is detected, the features extracted from the sub-blocks are summed up group by group, and it is determined by comparing the values acquired from two groups whether a watermark is embedded and if so, whether the watermark's bit is 1 or 0. It is possible, by accumulating local change of features, to render resistant to the random changes of features (stains, blurs, etc.) made on copying, printing and scanning, a document with a lot of noise and a document of low printing quality. The drawback of the described method is high computational cost.

Another related method, U.S. Patent application 2008/0292129, is directed to a method in which information is embedded as a plurality of data carrying dot patterns. Each dot pattern is embedded in a respective one of the determined blank blocks. Then the document with the embedded data carrying dot patterns is rendered and printed. The drawback of the described method is that the dot pattern may be apparent to observers.

### SUMMARY

The present general inventive concept provides an image forming apparatus which is capable of embedding digital information in a document by embedding a small white speckle in the text area of the document, a method of forming an image and a method of authenticating a document thereof.

Additional aspects and utilities of the present general inventive concept will be set forth in part in the description which follows and, in part, will be obvious from the description, or may be learned by practice of the present general inventive concept.

Features and/or utilities of the present general inventive concept may be realized by an image forming method including receiving an input of print data and a message, detecting a plurality of areas having a predetermined size from among printing areas of the input print data, generating the input message as a plurality of image patterns, embedding the generated plurality of image patterns in the detected plurality of areas, and printing print data in which the plurality of image patterns are embedded.

The detecting a plurality of areas may include detecting a plurality of areas which have a predetermined size from among a text area of print areas of the input print data.

The generating the input message may include converting the input image into a plurality of information bits and generating a plurality of image patterns for the converted plurality of information bits using image patterns corresponding to information bits.

The information bits may include information bit ‘0’, ‘1’, and stop information bit, and the converting the input image may include converting the input message into the information bits ‘0 ’ and ‘1 ’, and adding the stop information bit between bytes and to beginning and end of a message.

The image patterns may comprise a plurality of small white speckles against black background.

The small white speckles may have the size of 3×2 or 2×3 pixels.

The image forming method may further comprise extracting a plurality of embedding cells from the detected areas based on at least one of a horizontal line, distance between areas, and the number of areas on a single horizontal line, and the embedding may include embedding the plurality of image patterns in the plurality of cells.

The image forming method may further comprise converting the input print data into binary halftone images and the detecting and printing may use the converted binary halftone images.

Features and/or utilities of the present general inventive concept may also be realized by a document authentication method including scanning a document, detecting a plurality of areas having a predetermined size from the scanned document, searching an image pattern which includes small white speckles against black background from among the plurality of detected areas, converting the searched image pattern into a message, and authenticating the document using the converted message.

The white speckles may have the size of 3×2 or 2×3 pixels.

The searching an image pattern may include searching an image pattern in the plurality of detected areas based on at least one of a horizontal line, distance between areas, and the number of areas on a single horizontal line.

The image patterns may include image pattern ‘0’, ‘1’, and a stop image pattern.

Features and/or utilities of the present general inventive concept may also be realized by an image forming apparatus including a communication interface unit to receive an input of print data, a detection unit to detect a plurality of areas having a predetermined size from among print areas of the input print data, a controlling unit to generate a predetermined message as a plurality of image patterns, an embedding unit to embed the plurality of generated image patterns in the plurality of detected areas, and a printing unit to print print data in which the plurality of image patterns are embedded.

The detection unit may detect a plurality of areas which have a predetermined size from among a text area of print areas of the input print data.

The controlling unit may convert the input message into a plurality of information bits and generate a plurality of image patterns for the converted plurality of information bits using image patterns corresponding to information bits.

The information bits may include information bit ‘0’, ‘1’, and a stop information bit, and the controlling unit may convert the input message into the information bits ‘0’ and ‘1’, and add the stop information bit between bytes and to beginning and end of a message.

The image pattern may include a plurality of small white speckles against black background.

The small white speckles may have the size of 3×2 or 2×3 pixels.

The detection unit may extract a plurality of embedding cells from the detected areas based on at least one of a horizontal line, distance between areas, and ‘the number of areas on a single horizontal line’, and the embedding unit may embed the plurality of image patterns in the plurality of cells.

The controlling unit may convert the input print data into binary halftone images, and the detecting and printing may use the converted binary halftone images.

Features and/or utilities of another present general inventive concept may also be realized an image forming apparatus including a scanning unit to scan a document, a detection unit to detect a plurality of areas having a predetermined size from the scanned document, a search unit to search an image pattern including a plurality of small white speckles against black background from each of the plurality of detected areas and a controlling unit to convert the searched image pattern into a message and authenticate the document using the converted message.

The white speckles may have the size of 3×2 or 2×3 pixels.

The search unit may search an image pattern in the plurality of detected areas based on at least one of a horizontal line, distance between areas, and ‘the number of areas on a single horizontal line’.

The image pattern may include image pattern ‘0’, ‘1’, and a stop image pattern.

Features and/or utilities of the present general inventive concept may also be realized by a method to embed data in an image, the method including detecting areas of an image that have predetermined size dimensions and embedding data only in the detected areas having the predetermined size dimensions.

The areas of the image may correspond to text in the image, and embedding data only in the detected areas includes embedding the data only within pixels that make up the text of the image.

The predetermined size dimensions may include a minimum width and a maximum width greater than the minimum width.

Detecting the areas of the image that have the predetermined size dimensions may include determining whether an area that includes only one color has a width less than or equal to the maximum width and greater than or equal to the minimum width.

Embedding data only in the detected areas may include forming a strobe having a predetermined width at a location where a first detected area is detected, detecting a number of detected areas along the length of the strobe, determining whether the number of detected areas along the length of the strobe is equal to or greater than a minimum number of detected areas necessary to embed the hidden data in the detected areas corresponding to the strobe, and embedding the hidden data in the detected areas corresponding to the strobe only if the number of detected areas along the length of the strobe is equal to or greater than the minimum number of detected areas.

Embedding data only in the detected areas may further include forming a strobe having a predetermined width at a location where a first detected area is detected, detecting a distance between adjacent detected areas corresponding to the strobe, and discarding a detected area if the detected distance is less than a predetermined distance.

Features and/or utilities of the present general inventive concept may also be realized by an image forming apparatus including a detection unit to detect areas of an image that have predetermined size dimensions, an embedding unit to embedding data in the image only in the detected areas having the predetermined size dimensions, and a printing unit to print the image including the embedded data onto a recording medium.

Features and/or utilities of the present general inventive concept may also be realized by a method of detecting embedded data in an image, the method including detecting whether areas in an image have predetermined size dimensions, detecting whether the detected areas include embedded data, and extracting the data embedded in the detected areas that include embedded data.

Features and/or utilities of the present general inventive concept may also be realized by a scanning apparatus, including a scanning unit to scan a recording medium to generate an image, a detection unit to detect whether areas in the image have predetermined size dimensions, and a searching unit to determine whether the detected areas include hidden data and to output the hidden data.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a view illustrating the structure of a document authentication system according to the present general inventive concept;

FIG. 2 is a flow chart provided to explain a hidden message circulation according to the present general inventive concept;

FIG. 3 is a view illustrating patterns according to the present general inventive concept;

FIG. 4 is a flow chart illustrating the step of embedding a digital message in FIG. 2 in a halftone image in detail;

FIG. 5 is a view provided to explain the operation of detecting areas suitable for embedding patterns according to the present general inventive concept;

FIG. 6 is a view provided to explain the operation of determining positions of patterns for embedding according to the present general inventive concept;

FIG. 7A is a view illustrating examples of data and image fragments for embedding two-byte messages;

FIG. 7B illustrates an example structure of a two-byte message;

FIG. 7C illustrates an example of a hidden message located in text;

FIG. 8 is a flow chart explaining message extraction in FIG. 2 in detail;

FIG. 9 is a view illustrating detected areas on a scanned image for message extraction according to the present general inventive concept;

FIG. 10 is a view illustrating the operation of extracting symbols from one strobe according to the present general inventive concept; and

FIG. 11 is a block diagram illustrating the structure of an image forming apparatus according to the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

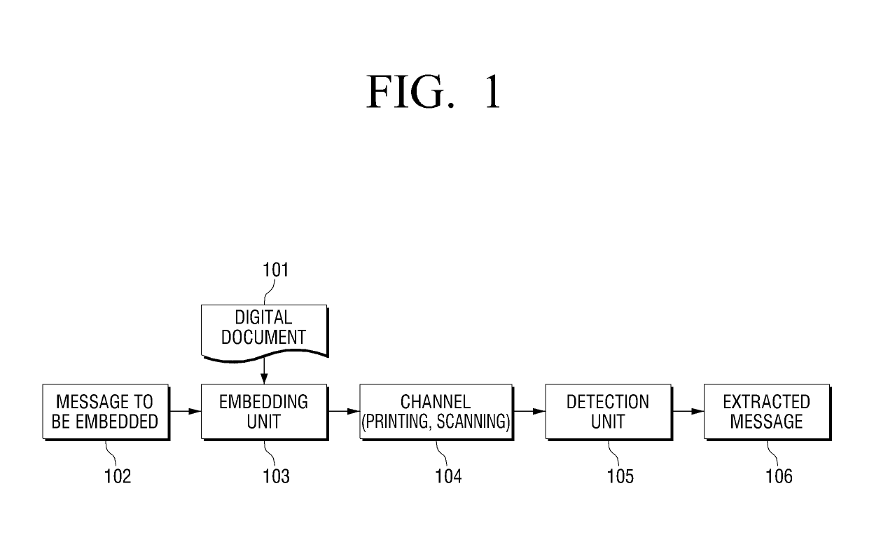

FIG. 1 is a view illustrating the structure of a document authentication system (or an image forming apparatus) according to the present general inventive concept.

Referring to FIG. 1, the document authentication system which embeds robust data (or digital information, or a message) comprises an embedder or embedding unit 103 and a detector or detection unit 105.

The embedder 103 may add the message or data to be embedded 102 to the input text document or digital document 101 and transmit the text document to which the message is added to the receiver point via the channel 104. The text document 101 may be considered a data carrier for transmission of digital information.

The channel can be divided in three stages: a printing stage, a paper utilization stage, and a scanning stage. Each stage may deteriorate the original image. The digital document 101 including the embedded message 102 may pass through one or more of the channels 104, i.e. one or more printing, paper handling, or scanning operations, before being transmitted to a detector or detection unit 105 to extract the embedded message or data 102. The extracted message may be used to check the authenticity of a document.

Meanwhile, implementation of the embedding unit 103 and detection unit 105 techniques depends on a printing system. Taking this into consideration, binary halftone images may be used as input and output data. Accordingly, it is necessary to emphasize black-white text information on a printed document totally defined by one halftone image (K—component for CMYK printing). Consequently, halftone binary images can be considered as raw data for printing without any additional modification by a printing system.

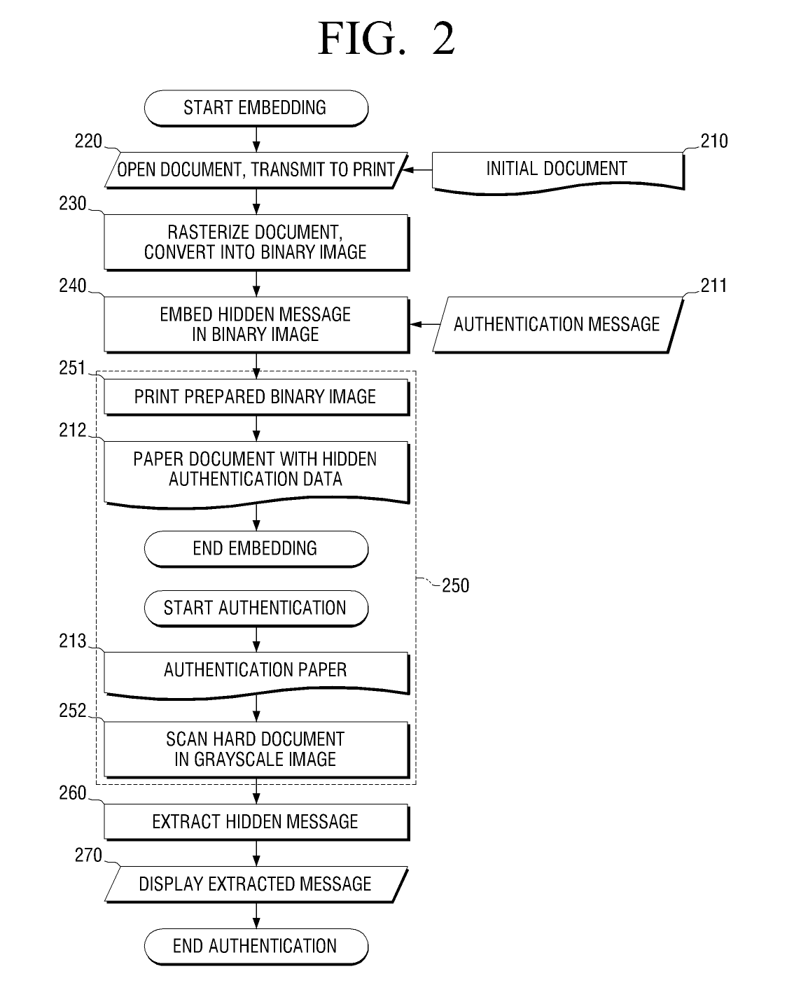

FIG. 2 is a flow chart provided to explain a process of generating and detecting a hidden message or hidden data according to the present general inventive concept.

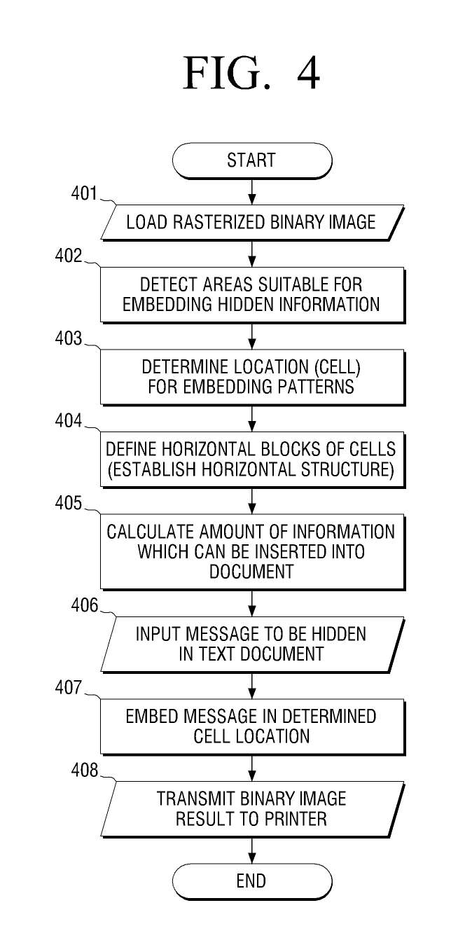

An original document 210 is stored in a buffer memory. In operation 220, the document 210 may be opened and/or transmitted to an imaging apparatus to be printed. In operation 230, the document 210 may be rasterized to be converted from common document formats (such as PDF, DOC, PS, etc.) into a binary image or binary halftone image via halftone screening. In operation 240, an authentication message, hidden message, or hidden data 211 may be embedded in the binary image. The operation of inserting the message into the binary image will be explained in greater detail with reference to FIG. 4, below. In operation 251, the modified binary image including the hidden data is printed onto a paper document or other recording medium 212.

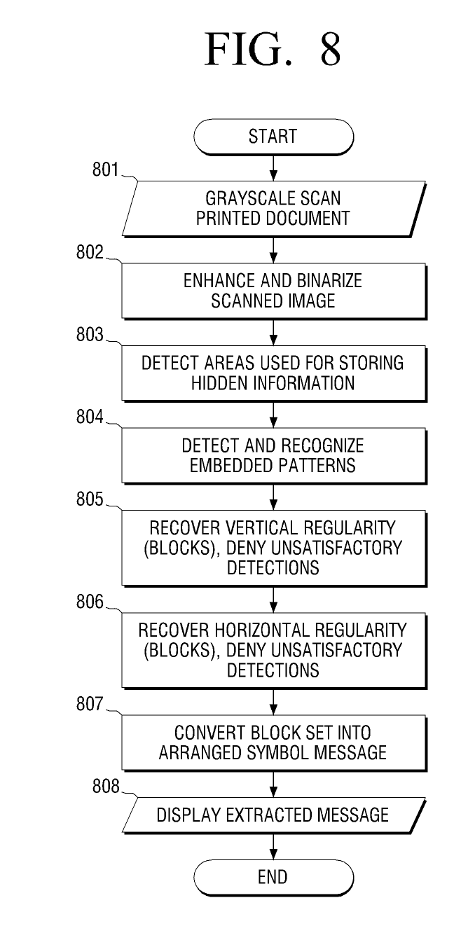

In operation 252, an authentication paper, paper document, or other recording medium 213 is scanned to generate a grayscale image. The paper document 213 may be the same as the paper document 212. Alternatively, the paper document 213 may be a product of one or more scanning, copying, and handling operations of the paper document 212. In operation 260, the hidden data embedded in the grayscale image is extracted. The operation of extracting the hidden information and analyzing the authenticity of the document will be explained in detail with reference to FIG. 8.

Block 250 of FIG. 2 represents the data transmission channel 104 in FIG. 1 which deteriorates an initial image through printing, a document's lifecycle, and scanning. The hidden message, hidden data, or authentication data may include metadata, a digital signature, ID labels, an author name, an authentication code, or any other data.

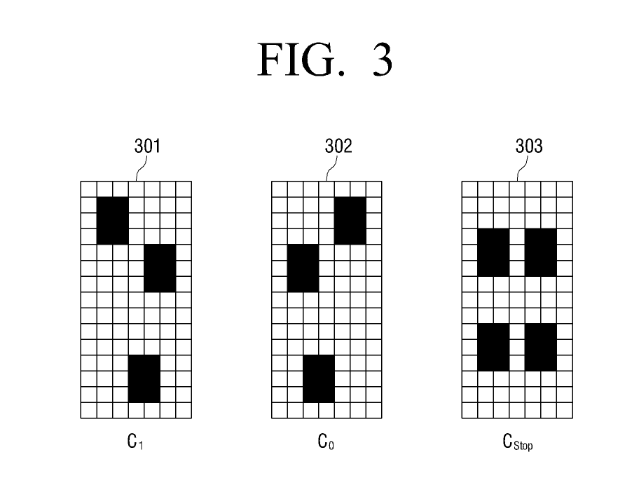

FIG. 3 is a view illustrating examples of data patterns according to the present general inventive concept. Although the blocks of pixels in FIG. 3 are illustrated as black blocks for illustration purposes, the pixels may be white blocks or specks in a portion of a document having a dark or black color.

FIG. 3 illustrates three patterns of speckles. Specifically, the patterns comprise several white speckles having a size of 3×2 or 2×3 pixels which do not adjoin with a black area border to avoid gapping (the black areas in FIG. 3 represent white speckles).

In accordance with FIG. 3, two patterns C₁ 301 and C₀ 302 are used to store informational bits 1 and 0, respectively. One special service pattern C_{Stop} 303 acts as a separator bit and is used for message or data structuring or ordering. The pattern C_{Stop} is used to separate bit sequences onto logical elements (bytes, for example) and to label boundaries of element groups. For example, if a 600 dpi printing resolution is assumed, and a text size not smaller than seven pixels in width (9-10 pt.) is used, then the patterns C1 (301), C0 (302) and Cstop (303) may have sizes of 7×15 pixels. However, other configurations and sizes may be used depending upon desired characteristics, font sizes, and resolutions, and more than 3 kinds of patterns may be used.

FIG. 4 is a flow chart illustrating in greater detail the operation of embedding a digital message in a halftone image.

In operation 401, a binary halftone image may be loaded into a memory device. The image may be partially loaded for band processing.

In operation 402, areas are detected in the binary halftone image that are suitable for embedding patterns. The embedding patterns may correspond to the patterns 301, 302, and 303 of FIG. 3, for example. In operation 403, the position of each embedding pattern or embedding cell may be detected by overlaying a vertical structure of an embedding pattern over the binary image. The vertical structure may correspond to a predetermined width, for example. If it is determined that an area of the binary halftone image has a width characteristic that corresponds to the width of the pattern, the area may be selected as an area that is potentially suitable for embedding patterns. In operation 404, the horizontal structure of the data of the hidden data or message may be established by determining how many blocks of a predetermined horizontal structure fit within the areas detected in operation 403. Consequently, all possible positions of patterns are determined and a plurality of ordered sequences is obtained.

In operation 405, the exact capacity of message is calculated based on the areas detected in operations 403 and 404. The amount of text, objects, and or images in a document may determine the maximal size of an embedded message or data.

In operation 406, the message content to be embedded is defined in accordance with the calculated capacity, and hidden information (or a message) is embedded in operation 407. After modification, the resulted binary image is printed on a black-and-white printer in operation 408.

Operations 402 and 403 include analysis of a binary halftone image (represented in the following equations by the symbol “X”) and determination of exact positions for each embedding pattern. Specifically, operation 402 provides a set of selected areas Xmap which are most preferable for hidden data embedding.

For detection of such suitable areas, two rectangle structuring elements Bmax (having a pixel size of 12×29) and Bmin (having a pixel size of 7×29 pixels) may be used. Bmax and Bmin restrict the possible size of detected areas for common embedding patterns. The following morphological operation may be used to define areas Xmap suitable for patterns embedding:

Xmap=X−X∘Bmax)∘Bmin; [Equation 1]

where X represents the initial binary image and ∘ represents an “opening” morphological operation. By performing the operation X−X∘ Bmax, all objects having a shape and size larger than Bmax are removed from consideration. For example, an object having a width, or a height, or a rectangular shape larger than the width, height, or rectangular characteristics of Bmax may be removed from consideration. Then, any areas corresponding to the structure Bmin are selected. Iterative calculations may be buffered and reused for future processing.

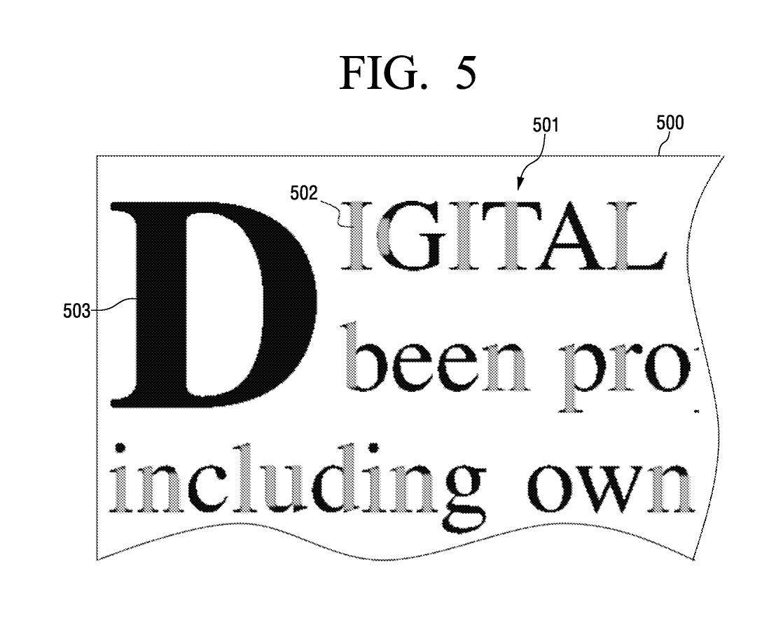

FIG. 5 illustrates a sample fragment 500 of a text document that consists of black text regions 501 on a white background. The areas detected by the above-describes process (Xmap) are represented by the reference numeral 502. As illustrated in FIG. 5, areas that have characteristics larger than a width of Bmax are discarded. For example, if Bmax is a block of 12×29 pixels, and if the “D” 503 includes a large block of text having a width greater than 12 pixels, then the area of the text 501 corresponding to the “D” 503 may be discarded from consideration as a location for the embedded message or data. On the other hand, since the areas 502 represented in gray fall within the bounds of Bmax and Bmin (having widths less than 12 pixels and greater than 7 pixels) then the areas 502 may be used to embed data.

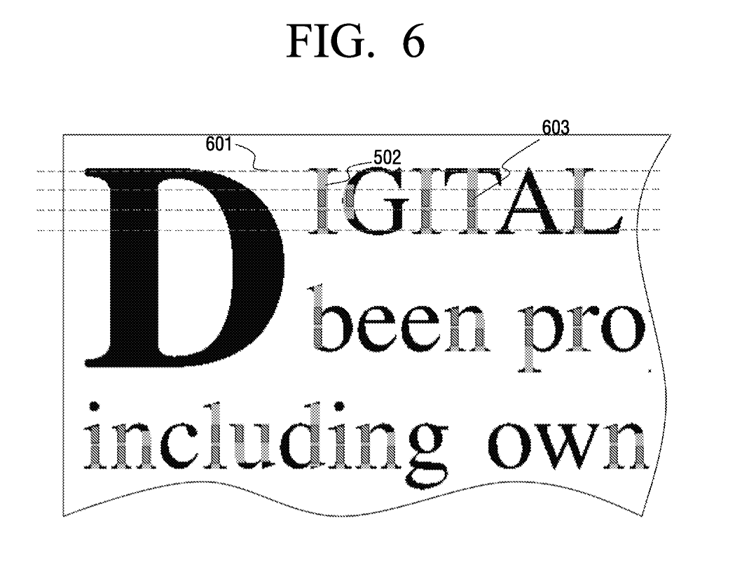

FIG. 6 illustrates operation 403 in which precise positions 603 of embedded patterns are determined within the predetermined areas 502. Positions of patterns are arranged within horizontally oriented narrow bands, or strobe bands, 601. A first strobe 601 is defined at the first detected area that is suitable for embedding data. For example, in FIG. 6, if the strobes are detected from the top of the document, then the first strobe would begin at the upper border of the “I,” “I,” “T,” and “L.” The strobes have a predetermined height. For example, the strobes may have a height equal to the cell's height plus three pixels. In such a case, if a pattern has a height of 15 pixels, then the strobe would have a height of 18 pixels. Although example configurations and processes have been presented to determine locations and widths of strobes, any appropriate method may be used to determine a strobe location and width. After the text is divided into strobes, it may be determined how many embedded pattern positions 603 may be located within the text.

In operation 404, the areas 502 detected in operation 402 and divided by strobes in operation 403 are analyzed to determine the embedded pattern positions 603. The embedded pattern positions 603 may then be blocked in a horizontal compact sequence (block) to form a horizontal data structure.

First, it may be determined that a detected area 502 is acceptable to include embedded pattern positions 603 only if the detected area 502 falls within predetermined minimum and/or maximum distance restrains from adjacent detected areas 502. For example, for the first detected strobe, a minimum distance between adjacent pattern positions 603 may be set at 150 pixels. On the other hand, for each other strobe, the minimum distance may be set at 500 pixels. The above parameters may provide scan skew robustness because parameters of skew compensation are calculated on the basis of first strobe detection results. One strobe may include several blocks if the distance between groups exceeds predetermined value. Moreover, the above parameters reduce false detections of informative bits during message extraction. In addition, the stop bits Cstop are used to protect against message corruption due to loss of bits or detecting false bits. Stop bits separate bit sequences into logical elements (bytes, for example) and label block boundaries.

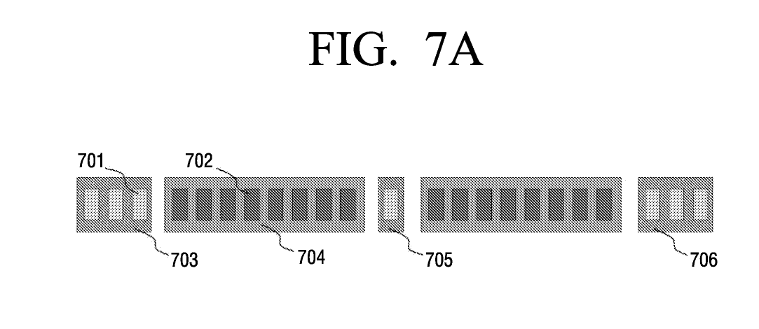

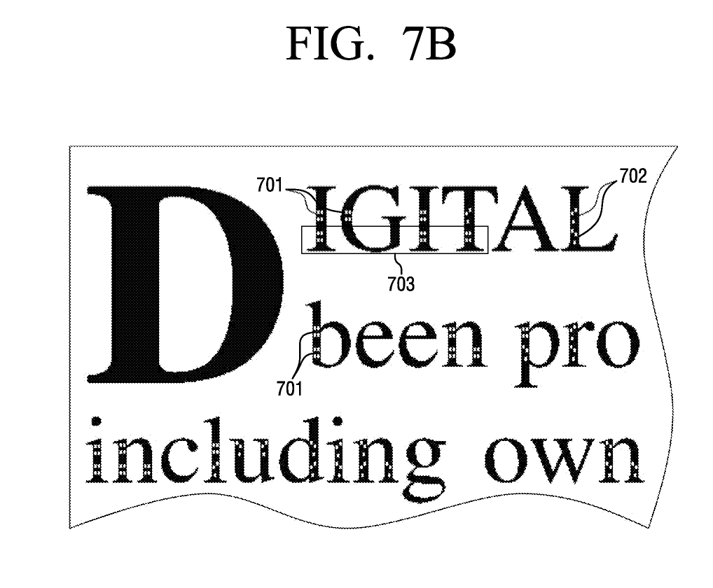

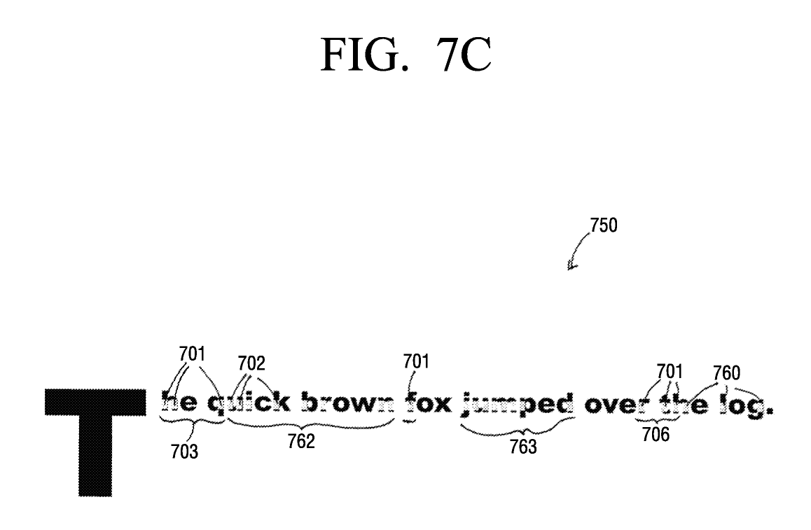

FIG. 7A illustrates an example of a two-byte block. In practice, the quantity of bytes in a block is limited only by text row capacity. The block may include a first label 703 to indicate a beginning of the block, another label 706 to indicate an and of the block, and one or more stop bit labels 705 to separate data segments, such as bytes, of the block. The beginning and ending labels 701 and 706 may comprise a plurality of sequential stop bits 701, for example. Each data segment (byte) 704 may include a plurality of informational bits 702 that are separated from adjacent data segments by a stop bit 705. Consequently, an arrangement of a plurality of patterns having a quantity N in a block may be defined by following equation:

R=N−(5+K·9), [Equation 2]

where K indicates a number of bytes to be embedded. In other words, if a predetermined number of pattern positions N (603) are available, then a number of the available pattern positions 603 that are needed to embed K bytes is calculated by the above equation. A resulting quantity R of pattern positions in each block may be discarded or not used. For example, if 20 pattern positions N (603) are available and only one byte is to be embedded, then R=20−(5+1·9), or 6. Then 6 of the pattern positions N (603) may be unused. If the quantity of available pattern positions N (603) is less than fourteen, the block of patterns is not used, since at least fourteen pattern positions N are needed to provided beginning and ending labels 703 and 706 of 3 bits each and one byte 704 of eight bits.

FIG. 7B illustrates a fragment 700 of a binary image having hidden data embedded therein. FIG. 7B illustrates block beginning labels 703, each including three stop bits 701. Information bits 702 may represent digital 1's and digital 0's, respectively, and may be part of data bytes of the hidden data.

FIG. 7C illustrates a portion 750 of a binary image having hidden data embedded therein. The embedded data is represented as gray boxes for illustration purposes. The illustrated segment of the binary image includes 26 available pattern positions. Since two bytes of data are to be embedded in the image, 23 of the pattern positions are used when six bits are added for beginning and ending labels 703 and 706 and one bit is added as a separation label 705. Consequently, three of the available positions may be unused. The block 760 of hidden data includes a beginning label 703 which may include three stop bits 701, a first byte of data 762, which includes eight data bits or information bits 702, a dividing stop bit label 705 including one stop bit 701, a second byte of data 763, and an ending label 706 including three stop bits 701. Three bits 760 are unused.

FIG. 8 is a flow chart illustrating in greater detail the extraction operation 260 of FIG. 2.

First, in operation 801 (operation 252 of FIG. 2), a grayscale digital copy of a document (213 of FIG. 2) is obtained. The resulting scanned image of the document 213 may be enhanced and binarized in operation 802. In operation 803, the image is analyzed to determine areas in which it is probably that an embedded hidden image may be located. The embedded patterns in areas selected in operation 803 are detected and the detection results are analyzed in operation 804. In operations 805 and 806 the hidden message structure is determined in vertical and horizontal directions, and false detections are recognized and rejected. The resulting detected block sets are converted into ordered messages in operation 807. In operation 808, the extracted message may be displayed to identify or authenticate the document 213. The extraction process will be described in greater detail below.

Generally, printing and then scanning procedures significantly affect image and change their appearance. Various techniques may be used in operation 802 to enhance and binarize the scanned image.

First, the brightness of the image may be compensated by stretching a brightness histogram of the image. The histogram may be stretched by cutting 3% off of the histogram (such as 1.5% off each end).

Second, the binarization of the contrasted image may be carried out by thresholding. In a binary image that results from the scanning operation 801, a “zero” value corresponds to a black level and a “one” value corresponds to a white level. The threshold image appears similar to original halftone image before the message embedding stage (operation 240 of FIG. 2) due to a decrease of the brightness of the speckles in a pattern during printing-scanning and, then, suppression of embedded speckles by thresholding. A de-noising filtration operation may be performed upon the image to further enhance the image. Often, a typical printing process is accompanied by the printing inequality which leads to alteration of forms and brightness of printed speckles for different printers. This undesired noise effect leads to missing areas of embedded information. To avoid such situation a simple filtration procedure with mask size 3×3 pixels is performed as follows:

$${y}_{ij} = \{ \begin{matrix}0 , & \begin{matrix}if [ {\hat{y}}_{i , j} = ‘ white ’ ] AND \\ [ {\sum }_{n = - 1}^{1} {\sum }_{m = - 1}^{1} if ( {\tilde{y}}_{( i + m ) , ( j + m )} = ‘ black ’ ) ] \geq 5\end{matrix} \\ {\tilde{y}}_{i , j}^{′} , & otherwise\end{matrix} \qquad [ Equation 3 ]$$

where \tilde{y}_{i,j} refers to a pixel of a thresholded image \tilde{Y}, and y_{i,j} refers to a pixel of filtration result Y.

As follows from described above equation only ‘white’ pixels are processed. Current ‘white’ pixel \tilde{y}_{i,j} is substituted for ‘black’ value if a quantity of all neighboring black pixels exceeds or equals 5.

Operation 803 defines areas with possible embedded marks in a set of areas (such as Yₘₐₚ, Xₘₐₚ) in accordance with the following expression:

Yₘₐₚ=(Y−Y∘Dₘₐₓ)∘Dₘᵢₙ, [Equation 4]

where structuring elements Dₘₐₓ and Dₘᵢₙ have sizes of 7×29 and 17×29 pixels, respectively. Dₘₐₓ is wider than Bₘₐₓ to account for situations in which symbol or text deformation has occurred.

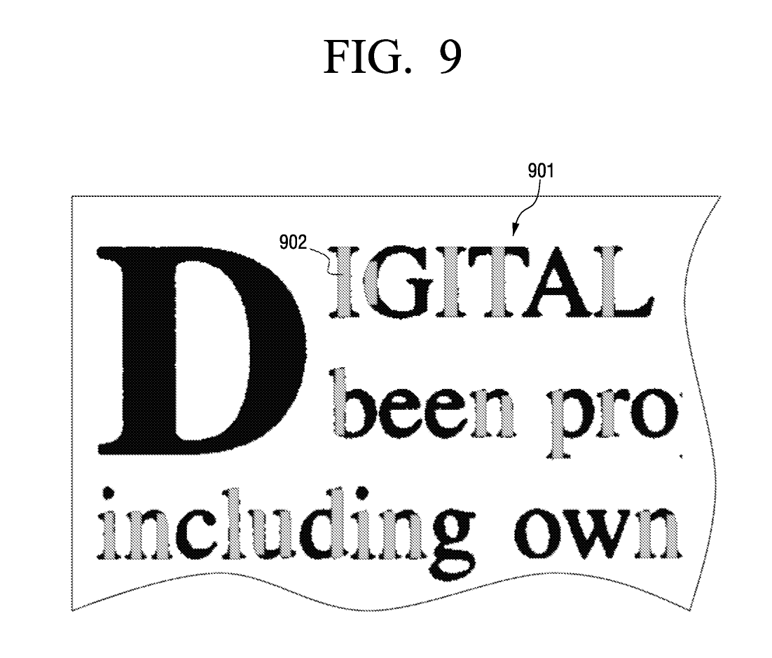

FIG. 9 is a view illustrating detected areas on a scanned image for message extraction according to the present general inventive concept.

In FIG. 9, all areas marked by gray 902 describe possible positions of embedded information in the text 901.

The detailed sub-routine of operation 804 in FIG. 8 comprises following steps. First, speckles that contain information are amplified in selected areas on the scanned grayscale image YεYₘₐₚ. Amplification may be performed by using an eight-neighbor Laplacian equation defined as follows:

$${y}_{i , j} = ( {\sum }_{n = - 1}^{1} {\sum }_{m = - 1}^{1} {h}_{( m + 1 ) , ( n + 1 )} \cdot {y}_{( i + m ) , ( j + m )} ) , \\ for {y}_{i , j} ∈ {Y}_{map} , \\ where h = [ \begin{matrix}- 1 & - 1 & - 1 \\ - 1 & 8 & - 1 \\ - 1 & - 1 & - 1\end{matrix} ] . \qquad [ Equation 5 ]$$

As second step for detection and recognition of embedded patterns, matched filtering may be performed. As convolution kernels, the speckle clusters C₁, C₁ and C_{Stop} are used. A spatial liner filtering of one image count y_{i,j} by kernel C as F [y_{i,j},C] may be performed.

$$F [ {y}_{i , j} , {C}_{( • )} ] = {\sum }_{n = - \frac{N - 1}{2}}^{\frac{N - 1}{2}} {\sum }_{m = - \frac{M - 1}{2}}^{\frac{M - 1}{2}} {y}_{( i + n ) , ( j + m )} \cdot {C}_{( n - \frac{N - 1}{2} ) , ( m - \frac{M - 1}{2} )} \qquad [ Equation 6 ]$$

where C_{(□)}—one from used kernels.

Consequently, a filtration result is defined as a maximal response from three filters:

y_{i,j}^{max}=max{F[y_{i,j},C₁],F[y_{i,j},C₀],F[y_{i,j},C_{Stop}]} for y_{i,j}εYₘₐₚ

To speed up filtration by reducing noise results, only the counts that exceed a predetermined threshold are taken into account. Threshold may be equal to 15, for example. While the thresholding step is not necessary, it does speed up the calculation process.

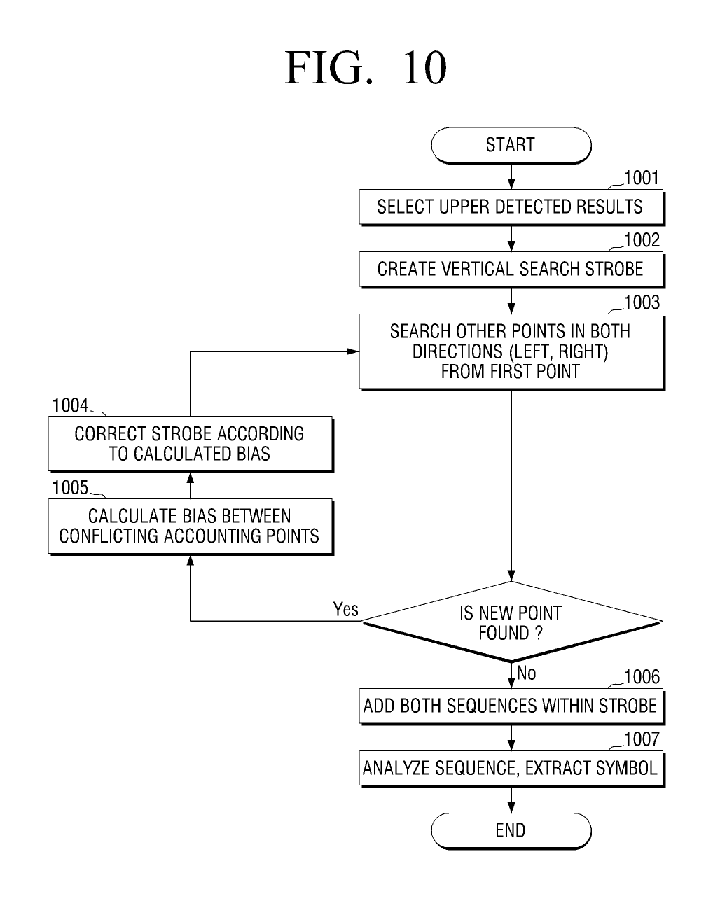

The embedded message has a positional dependent structure and the locations of each element in the blocks influence the message detection result. To recover, detect, or reconstruct the structure of the hidden message or data, operations 805 and 806 of FIG. 8 are necessary to order detected patterns and eliminate noise. The operation of message recover will be explained in further detail with reference to FIG. 10.

In order to prevent mixing-up, all blocks within a coordinate are rearranged in ascending order, and symbol group results are combined as one message in operation 807.

FIG. 10 is a view illustrating the operation of extracting symbols or data from one strobe according to the present general inventive concept.

In operation 1001, an upper detected result is selected. In other words, a location of the upper-most detected hidden data pattern is selected. Then in operation 1002, starting from the selected point, the neighboring elements or patterns in the same horizontal strobe are searched with a vertical search strobe. The strobe height may equal a height of the patterns, such as 15 pixels, for example. Specifically, in operation 1003, a search is carried out in both (left and right) directions from first selected point within the horizontal strobe to detect additional data patterns or elements. For each new detected pattern or element within the analyzed strobe, a local bias between conflicting detected points is calculated in operation 1005. In other words, it is determined whether the scanned image is at an angle with respect to the horizontal strobe, and the angle of the horizontal strobe may be adjusted accordingly. In operation 1004, the strobe correction may be performed using the calculated local bias. Except for the first strobe, a strobe may be corrected by using the averaged sum of current local bias and bias for a previous strobe. Moreover, the bias of the previous strobe may be given a larger weight than that of the present strobe when the bias of the present and previous strobes are summed. Such approach compensates scan skew up to 1.5-2 degrees.

Upon completion of the search within the current strobe, two sequences of detection results for each direction are obtained. Both strobe sequences are merged in one in operation 1006. Then, all elements in sequence are analyzed and symbols in the results are extracted in operation 1007. The analysis in operation 1007 may include five general conditions which are closely interrelated with the embedding stage. First, a distance between neighborhood elements shouldn't exceed 500 pixels. Second, all results of detection within a current searching strobe should be distributed along one line. Specifically, possible deviance should not exceed 5 pixels in both directions from the line. Third, in beginning and end of block a stop bits quantity should be no less than 2. Fourth, a quantity of elements within a block should be no less than 10. And fifth, parameters of skew compensation for a current block may not differ significantly from other lines. For a first strobe, a minimal distance from a current point to a neighboring element should not exceed 150 pixels.

Elements and blocks which satisfy the above conditions are presumed valid. Rejected elements and blocks are removed from further processing. Resulting bit arrays are ordered from left side to right in accordance with beginning and ending labels of detected blocks. Operation 1007 results in the separation of existing blocks and the extraction of embedded symbols or data. Specifically, extracted logical elements (such as symbols) which contain fewer or more bits than are necessary are marked as damaged symbols. Due to the use of separation stop bits, missing one bit does not lead to corruption of a whole message. Instead, only one byte will damaged. The use of redundant coding may increase message robustness significantly. The procedure described on FIG. 10 may be repeated for each strobe.

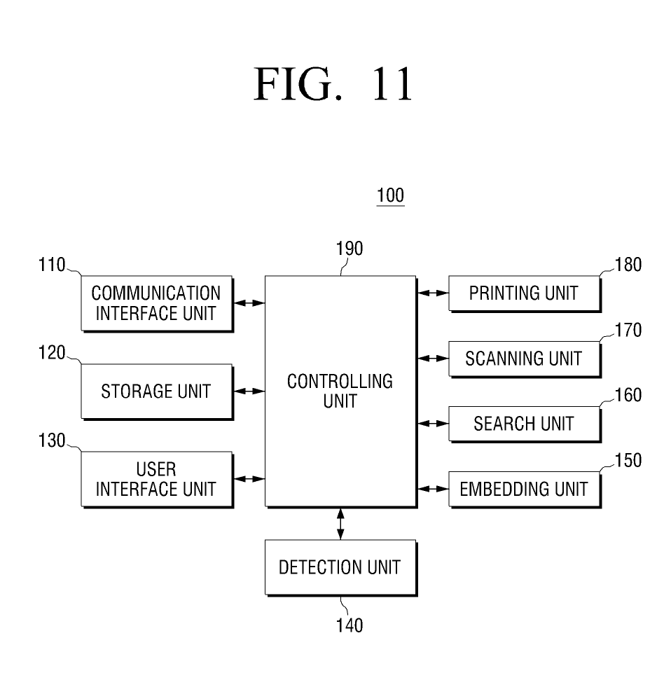

FIG. 11 is a block diagram illustrating the structure of an image forming apparatus according to the present general inventive concept.

Referring to FIG. 11, the image forming apparatus 100 may comprise a communication interface unit 110, a storage unit 120, a user interface unit 130, a detection unit 140, an embedding unit 150, a search unit 160, a scanning unit 170, a printing unit 180, and a controlling unit 190.

The communication interface unit 110 is connected to a printing controlling terminal (not shown) such as PC, notebook PC, PDA, and digital camera, and receives print data. Specifically, the communication interface unit 110 allows the image forming apparatus 100 to be connected to an external apparatus, and may be connected to a printing control terminal not only through a local area network (LAN) or an Internet network but also through a universal serial bus (USB) port. In addition, the communication interface unit 110 may receive a message to be embedded in print data from a printing controlling terminal.

The storage unit 120 stores print data which are received from the printing control terminal (not shown) through the communication interface unit 110. The storage unit 120 may pre-store the message which will be embedded in print data or may store the message after receiving it through the communication interface unit 110 or the user interface unit 130. In addition, the storage unit 120 may store a pattern image as illustrated in FIG. 3. The storage unit 120 may be implemented as a storage medium inside the image forming apparatus 100 or an external storage medium such as a removable disk including a USB memory, a storage medium connected to a host, and a web server based on a network.

The user interface unit 130 may display document authentication results in the process of document authentication. Specifically, the user interface unit 130 may display a message which is converted by the controlling unit 190 or authentication result according to the converted message to a user. The controlling unit 190 will be explained later. Meanwhile, the user interface unit 130 comprises a plurality of function keys through which the user may set or select various functions supported by the image forming apparatus, and displays various information provided by the image forming apparatus. The user interface unit 140 may be implemented as a touch pad or similar device capable of inputting and, or a device in which a mouse and a monitor are combined. The user may input a message to be embedded in a document through a user interface window displayed on the user interface unit 130.

The detection unit 140 detects a plurality of areas which have a predetermined size from among the printing areas of the input print data. Specifically, if the image forming apparatus 100 embeds a message, the detection unit 140 may detect a plurality of areas having a predetermined size of text area from among the printing areas of the input print data. If the image forming apparatus performs document authentication, the detection unit 140 may detect a plurality of areas having a predetermined size from scanned data.

In addition, the detection unit 140 may extract a plurality of embedding cells considering a horizontal line, distance between areas, and the number of areas on a single horizontal line from among detected areas. The detailed operation of detecting a plurality of areas and extracting a plurality of embedding cells have been explained above with reference to FIGS. 4 to 6, and thus further explanation will not be provided.

The detection unit 140 may include software stored in memory executed by a processor to analyze a digital image to perform the above detection operations and output corresponding detection results. The detection unit 140 may include additional logic units and other circuitry to receive, analyze, and output data.

The embedding unit 150 inserts a plurality of generated image patterns into a plurality of detected areas. Specifically, the embedding unit 150 may sequentially add a plurality of image patterns generated by the controlling unit 190 to each extracted embedding cell from among a plurality of areas detected by the detection unit 140. The embedding unit 150 may include software stored in memory executed by a processor to manipulate a digital image to perform the above-described embedding operations. The embedding unit 150 may include additional logic units and other circuitry to receive, analyze, and output data.

The search unit 160 searches image patterns which include a plurality of white speckles against black background from among each of the plurality of detected areas. Specifically, the search unit 160 may search whether an image pattern is embedded in the area searched by the detection unit 140. The detailed operation of searching an embedded image pattern has been explained above with reference to FIG. 8 to FIG. 10, and thus further explanation will not be provided.

The scanning unit 170 scans an input document. Specifically, the scanning unit 170 may scan the input document and convert the scanned document into binary halftone images. In addition, the scanning unit 170 may perform image processing and filtering on the scanned image as explained above with reference to FIG. 8. The scanning unit 170 may include one or more scanners, including light emitting devices to emit light onto a recording medium and sensors to detect the light reflected off of the recording medium and to convert the detected light into electrical signals to generate the scanned image.

The printing unit 180 prints print data to which image patterns are embedded. Specifically, the printing unit 180 may print print data to which image patterns are embedded while embedding a message. The printing unit 180 may include one or more rollers, including transfer rollers, intermediate rollers, and photosensitive rollers to transfer an image from a photosensitive roller to a recording medium. Alternatively, the printing unit 180 may include ink-emitting nozzles to transmit ink to a recording medium.

The controlling unit 190 controls each element of the image forming apparatus 100. Specifically, if print data is received through the communication interface unit 110, the controlling unit 190 controls the detection unit 150 to detect a plurality of areas having a predetermined size from among the printing areas of the input print data.

In addition, the controlling unit 190 generates an input message in a plurality of image patterns. Specifically, the controlling unit 190 may convert the input message into a plurality of information bits and generate a plurality of image patterns for the converted plurality of information bits using image patterns corresponding to the information bits. The information bits include information bit ‘0’, ‘1’, and a stop bit.

The controlling unit 190 may control the embedding unit 150 to embed a plurality of generated image patterns in a plurality of detected areas and control the printing unit 180 to print print data in which a plurality of image patterns are embedded.

If a document is disposed in the scanning unit 170, the controlling unit 190 may control the scanning unit 170 to scan the disposed document, control the detection unit 140 to detect a plurality of areas having a predetermined size from among the scanned document, control the search unit 160 to search an image pattern which includes a plurality of small white speckles from among the detected areas, convert the searched image pattern into a message, and perform authentication on the scanned document using the converted message.

According to the above exemplary embodiment, the image forming apparatus 100 may embed authentication information in a document without any particular device since the image forming apparatus 100 adds a digital message in an image pattern including invisible white speckles to the document.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents. For example, data may be generated and detected along a vertical strobe instead of a horizontal strobe, speckle patterns may have various dimensions other than those specifically described above, colors other than black may be used to form an image or to detect hidden data in an image, hidden data may be stored in objects and pictures of a document, etc. Alternatively, hidden data may be stored only in text of an image, or only grayscale or black-and-white images may be used to embed hidden data or detect hidden data.

What is claimed is:

1. An image forming method, comprising:
receiving an input of print data and a message;
detecting a plurality of areas having a predetermined size from among printing areas of the input print data;
generating the input message as a plurality of image patterns;
embedding the generated plurality of image patterns in the detected plurality of areas; and
printing print data in which the plurality of image patterns are embedded.

2. The image forming method of claim 1, wherein the detecting a plurality of areas includes detecting a plurality of areas which have a predetermined size from among a text area of print areas of the input print data.

3. The image forming method of claim 1, wherein generating the input message comprises:
converting the input image into a plurality of information bits; and
generating a plurality of image patterns for the converted plurality of information bits using image patterns corresponding to information bits.

4. The image forming method of claim 3, wherein the information bits include information bits ‘0’ and ‘1’ and a stop information bit, and
converting the input image includes converting the input message into the information bits ‘0’ and ‘1’, and adding the stop information bit between bytes and at a beginning and end of a message.

5. The image forming method of claim 1, wherein the image patterns comprise a plurality of small white speckles against black background.

6. The image forming method of claim 4, wherein the small white speckles have dimensions of 2×3 or 3×2 pixels.

7. The image forming method of claim 1, further comprising:
extracting a plurality of embedding cells from the detected areas based on at least one of a horizontal line, a distance between areas, and a number of areas on a single horizontal line,
wherein the embedding includes embedding the plurality of image patterns in the plurality of cells.

8. The image forming method of claim 1, further comprising:
converting the input print data into binary halftone images,
wherein the detecting and printing use the converted binary halftone images.

9. A document authentication method, comprising:
scanning a document;
detecting a plurality of areas having a predetermined size from the scanned document;
searching an image pattern which includes small white speckles against black background from among the plurality of detected areas;
converting the searched image pattern into a message; and
authenticating the document using the converted message.

10. The document authentication method of claim 9, wherein the white speckles have dimensions of 2×3 or 3×2 pixels.

11. The document authentication method of claim 9, wherein searching the image pattern includes searching an image pattern in the plurality of detected areas based on at least one of a horizontal line, a distance between areas, and a number of areas on a single horizontal line.

12. The document authentication method of claim 9, wherein the image patterns includes image pattern ‘0’, ‘1’, and a stop image pattern.

13. An image forming apparatus, comprising:
a communication interface unit to receive an input of print data;
a detection unit to detect a plurality of areas having a predetermined size from among print areas of the input print data;
a controlling unit to generate a predetermined message as a plurality of image patterns;
an embedding unit to embed the plurality of generated image patterns in the plurality of detected areas; and
a printing unit to print print data in which the plurality of image patterns are embedded.

14. The image forming apparatus of claim 13, wherein the detection unit detects a plurality of areas which have a predetermined size from among a text area of print areas of the input print data.

15. The image forming apparatus of claim 13, wherein the controlling unit converts the input message into a plurality of information bits and generates a plurality of image patterns for the converted plurality of information bits using image patterns corresponding to information bits.

16. The image forming apparatus of claim 15, wherein the information bits include information bit ‘0’, ‘1’, and a stop information bit, and
the controlling unit converts the input message into the information bits ‘0’ and ‘1’, and adds the stop information bit between bytes and to beginning and end of a message.

17. The image forming apparatus of claim 13, wherein the image pattern includes a plurality of small white speckles against black background.

18. The image forming apparatus of claim 17, wherein the small white speckles have dimensions of 2×3 or 3×2 pixels.

19. The image forming apparatus of claim 13, wherein the detection unit extracts a plurality of embedding cells from the detected areas based on at least one of a horizontal line, a distance between areas, and a number of areas on a single horizontal line, and
the embedding unit embeds the plurality of image patterns in the plurality of cells.

20. The image forming apparatus of claim 13, wherein the controlling unit converts the input print data into binary halftone images, and
the detecting and printing use the converted binary halftone images.

21. An image forming apparatus, comprising:
a scanning unit to scan a document;
a detection unit to detect a plurality of areas having a predetermined size from the scanned document;
a search unit to search an image pattern including a plurality of small white speckles against black background from each of the plurality of detected areas; and
a controlling unit to convert the searched image pattern into a message and authenticate the document using the converted message.

22. The image forming apparatus of claim 21, wherein the white speckles have dimensions of 2×3 or 3×2 pixels.

23. The document authentication method of claim 21, wherein the search unit searches an image pattern in the plurality of detected areas based on at least one of a horizontal line, a distance between areas, and a number of areas on a single horizontal line.

24. The document authentication method of claim 21, wherein the image pattern include image pattern ‘0’, ‘1’, and a stop image pattern.

25. A method to embed data in an image, the method comprising:
detecting areas of an image that have predetermined size dimensions; and
embedding data only in the detected areas having the predetermined size dimensions.

26. The method according to claim 25, wherein the areas of the image correspond to text in the image, and
embedding data only in the detected areas includes embedding the data only within pixels that make up the text of the image.

27. The method according to claim 25, wherein the predetermined size dimensions include a minimum width and a maximum width greater than the minimum width.

28. The method according to claim 27, wherein detecting the areas of the image that have the predetermined size dimensions includes determining whether an area that includes only one color has a width less than or equal to the maximum width and greater than or equal to the minimum width.

29. The method according to claim 25, wherein embedding data only in the detected areas comprises:
forming a strobe having a predetermined width at a location where a first detected area is detected;
detecting a number of detected areas along the length of the strobe;
determining whether the number of detected areas along the length of the strobe is equal to or greater than a minimum number of detected areas necessary to embed the hidden data in the detected areas corresponding to the strobe; and
embedding the hidden data in the detected areas corresponding to the strobe only if the number of detected areas along the length of the strobe is equal to or greater than the minimum number of detected areas.

30. The method according to claim 25, wherein embedding data only in the detected areas further comprises:
forming a strobe having a predetermined width at a location where a first detected area is detected;
detecting a distance between adjacent detected areas corresponding to the strobe; and
discarding a detected area if the detected distance is less than a predetermined distance.

31. An image forming apparatus, comprising:
a detection unit to detect areas of an image that have predetermined size dimensions;
an embedding unit to embedding data in the image only in the detected areas having the predetermined size dimensions; and
a printing unit to print the image including the embedded data onto a recording medium.

32. A method of detecting embedded data in an image, the method comprising:
detecting whether areas in an image have predetermined size dimensions;
detecting whether the detected areas include embedded data; and
extracting the data embedded in the detected areas that include embedded data.

33. A scanning apparatus, comprising:
a scanning unit to scan a recording medium to generate an image;
a detection unit to detect whether areas in the image have predetermined size dimensions; and
a searching unit to determine whether the detected areas include hidden data and to output the hidden data.
